(19) United States
(12) Patent Application Publication
(10) Pub. No.: US 2018/0200813 A1
(43) Pub. Date: Jul. 19, 2018

(54) METHOD FOR FINE PROCESSING A TOOTHING, A FINE PROCESSING MACHINE FOR PERFORMING THE METHOD AND A COMPUTER PROGRAM FOR CONTROLLING THE MACHINE

(71) Applicant: GLEASON-PFAUTER MASCHINENFABRIK GMBH, Ludwigsburg (DE)

(72) Inventor: Josef Schnell, Neufahrn bei Freising (DE)

(21) Appl. No.: 15/743,688

(22) PCT Filed: Jul. 11, 2016
(86) PCT No.: PCT/EP2016/001192

§ 371 Date: Jan. 11, 2018

(30) Foreign Application Priority Data
Jul. 14, 2015 (DE) 10 2015 009 154.9

(51) Int. Cl. B23F 5/06; B23F 19/00; B23F 19/06

(52) U.S. Cl. CPC B23F 5/06; B23F 19/06; B23F 19/005

(57) ABSTRACT

The invention relates to a method for the fine-processing of a toothing by a single-indexing method, wherein a disk-type fine-toothing machine (S) that rotates about its axis is brought into rolling processing engagement with a tooth flank of the toothing in order to remove material from the tooth flank, wherein a line contact is established while in processing engagement, and the contact line moves over the tooth flank in accordance with a movement having a directional component (Xc0) that is radial to the toothing axis (C), and wherein the processing engagement is maintained in the same pitch with a reduced tangential distance between the tooth flank and the disk plane of the fine-processing tool and with a sign reversal of the radial directional component of the contact line displacement.

The invention relates to a method for the fine-processing of a toothing by a single-indexing method, wherein a disk-type fine-toothing machine that rotates about its axis is brought into rolling processing engagement with a tooth flank of the toothing in order to remove material from the tooth flank, wherein a line contact is established while in processing engagement, and the contact line moves over the tooth flank in accordance with a movement having a directional component that is radial to the toothing axis, and it relates to a controlled fine-processing machine that is suitable for performing the aforementioned method.

Fine-processing machines of this type, which are produced by the single-indexing method, are used to sharpen shaving cutters, for example. In the single-indexing method, a processing process is performed on a tooth flank of the toothing that is being processed; the toothing subjected to processing is then rotated about its toothing axis (indexing) so that the tooth flank of the next tooth undergoes the processing, and so forth until the tooth flanks of all teeth in the toothing have been processed on one flank side in a cycle.

Typically, the material is not ground down to the desired final dimensions in a single cycle, but the grinding is instead carried out in several steps (cycles). The greatest amount of material is removed during the first (roughing) cycles, and less material is removed in the subsequent (finishing) cycles, in which the grinding precision is increased. Following each cycle, in which a predetermined amount is ground off, a new infeed is set to reduce the distance between the tooth flank to be processed and the grinding disk, thereby corresponding to the amount chosen to be removed in the next cycle. Additionally, once the desired final geometry is achieved, so-called “spark-out cycles” can also be performed, which are carried out without any further infeed and without force.

As soon as all tooth flanks on a flank side, e.g. the left flanks, have been ground for the predetermined number of cycles, the clamps can be removed from the toothing, and the toothing, e.g. the shaving cutter, can be turned around and reclamped, whereupon the processing of the other flank side, in this case the right side, can commence.

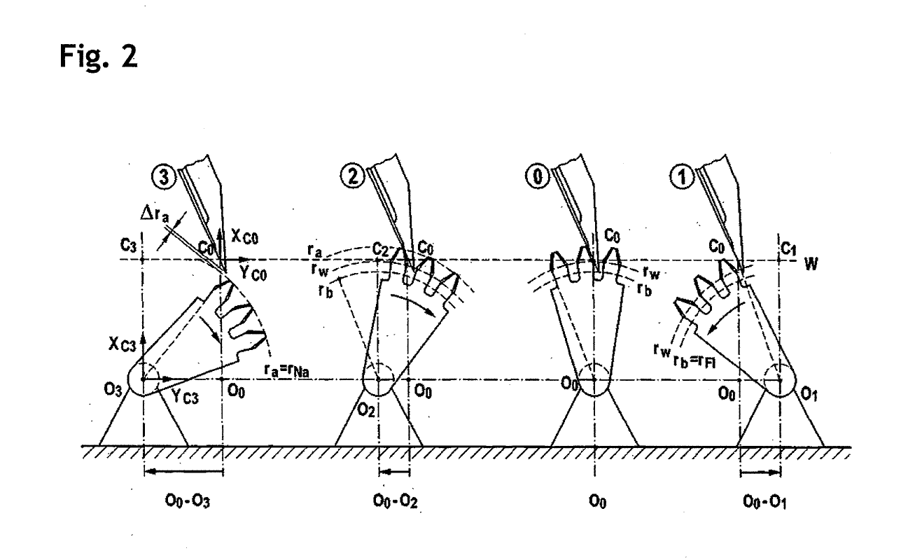

The rolling processing engagement is achieved by following the principle of the classic process using a rolling arc with simultaneous translational displacement of the toothing axis. This principle is addressed on page 63 of the company publication “Das SRS Buch” by Dr. Schriefer, Munich, July 1988, wherein the explanation that appears there is included in the present application as FIG. 2 and reference is made e.g. to that work when discussing the principle, although a person skilled in the art is well-acquainted with it. The indexing occurs in the position designated 3 in FIG. 2, and by the subsequent coordinated rotation of the toothing along with the axial movement, the grinding disk rolls into the toothing to form a line contact. The contact line moves across the tooth flank until the entire tooth flank has been ground and (in position 1 in FIG. 2) the reversal point for the linear movement between the toothing and the grinding disk has been reached. During what is known as the return stroke, the grinding disk is then withdrawn from the toothing until it returns to position 3 and there is no longer any engagement. The toothing is indexed there, after which the tooth flank of the next tooth is processed. After one processing cycle, the next processing cycle occurs with a further infeed.

Moreover, a grinding process (the so-called MAAG grinding process) is known in which a point contact, rather than a line contact, is established between the involute surface of the toothing and the surface of the grinding disk. Here, the tooth flank is ground over its entire surface as a result of an additional oscillation of the grinding disk through the tooth gap along the width of the toothing.

By contrast, in methods of the aforementioned type, no further axial movements are required after the required basic positioning and adjustment movements apart from superimposing the rotation of the toothing and the translational stroke movement over an entire cycle, which is needed for rolling engagement, and excellent results in terms of processing precision and processing time are achieved as a result.

The invention addresses the problem of further improving a method of the type described above.

The invention solves this problem by developing a method of the aforementioned type, which is essentially characterized in that the processing engagement is maintained in the same pitch with a reduced tangential distance between the tooth flank and the disk plane of the fine-processing tool and with a sign reversal of the radial directional component of the contact line displacement.

Thus the invention is based on the recognition that, contrary to the idea of minimizing the necessary axial movements as described above and implementing a simple and time-saving machine control system on the basis of the minimized simple repeated axial movements, the processing time can be reduced by means of additional axial movements, namely an extra infeed motion that reduces the tangential distance between the tooth flank and the disk plane of the fine-processing tool in the same pitch. By performing this movement before the algebraic sign of the radial directional component of the contact line displacement is reversed, it is possible to establish further processing engagement, limited by the reduced tangential distance, with a contact line displacement and with a reversed radial directional component. The return stroke is thus deliberately carried out with a deeper infeed to remove material. This permits the number of processing cycles to be reduced without increasing the risk of grinding burn due to excessive material removal in a processing engagement.

In an especially preferred embodiment, the tangential distance for the processing engagement is increased again on the next tooth flank after (each) indexing, in particular by the same amount as the preceding reduction. In this way, viewed via the individual tooth gaps in the toothing, a uniform removal of material is achieved throughout the cycle.

In the method according to the invention, it is also practical for the total amount of material removed to achieve the desired final dimensions to be distributed over multiple processing cycles of the toothing. In so doing, it is preferable that the process can be continued in one or more processing cycles, in particular in the first processing cycle, with a reduction in the tangential distance and the sign reversal in the radial directional component in the respective pitch. Thus it is certainly possible that individual processing cycles could also be carried out in accordance with the prior art described above, and it is possible in particular that the tangential distance is not reduced in the final cycle, in which material is deliberately removed. This is normally the last finishing cycle and not the last cycle altogether, insofar as spark-out cycles are also performed.

Therefore, the invention should not be understood to mean that a continuation of the processing engagement with a deeper infeed must take place in the return stroke during every processing cycle; in fact, the method according to the invention is distinguished by the fact that this measure is undertaken in at least one processing cycle.

In a preferred variant, a relative movement between the fine-processing tool and the processing of the toothing to establish the processing engagement is, by its very nature, that of a mechanical rolling arc, though it is carried out by synchronized CNC-controlled axes of movement. This is the superimposition of the tangential stroke movement and the rotation of the toothing that was mentioned previously.

With the CNC-controlled machine axes available today, it is basically possible to achieve a relative movement between the tool and the toothing by moving the toothing, moving the tool or moving both, and the invention is not further restricted in this regard. It is especially preferred, however, for the relative movement to be produced by superimposing a rotational movement of the toothing and a linear movement of the toothing transversely to its rotary axis. The toothing thus moves actively.

In this context, the fine-processing tool preferably does not perform any other movements besides its rotational movement during a processing cycle of the toothing. In this variant, the is carried out on the toothing side in order to reduce the tangential distance before the sign reversal of the radial directional component of the contact line displacement.

In a practical embodiment, the processed toothing is the toothing of a cylindrical gear-cutting tool. Here is where the precision achieved by the method shows its value. The cylindrical tool could be a cutting wheel (impact cutter), for example. In particular, it is also possible that a shaving cutter can be ground by this method.

Protection is additionally sought by the invention for a computer program that, when run on a fine-processing machine suitable for performing a method of the aforementioned type, controls the fine-processing machine to perform a method of the aforementioned type.

Also protected is a fine-processing machine, in particular a shaving cutter grinding machine, with a controller that controls the machine to carry out a method in accordance with one of the aforementioned aspects of the method. Said machine does not have to differ from known shaving cutter grinding machines with respect to its available axes of movement. Nevertheless, the machine's controller contains the control commands that execute the method and that are implemented by machine technology.

Further features, details and advantages of the invention arise from the following description of a preferred embodiment with reference to the attached drawings, of which

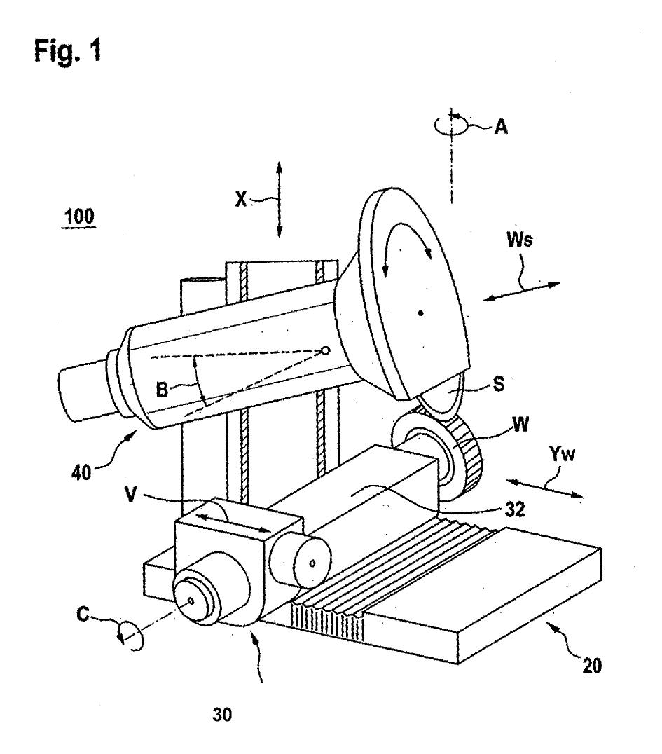

FIG. 1 shows a shaving cutter grinding machine,

FIG. 2 shows an explanatory rendering of the rolling and sub-kinematics of a shaving cutter grinding machine, and

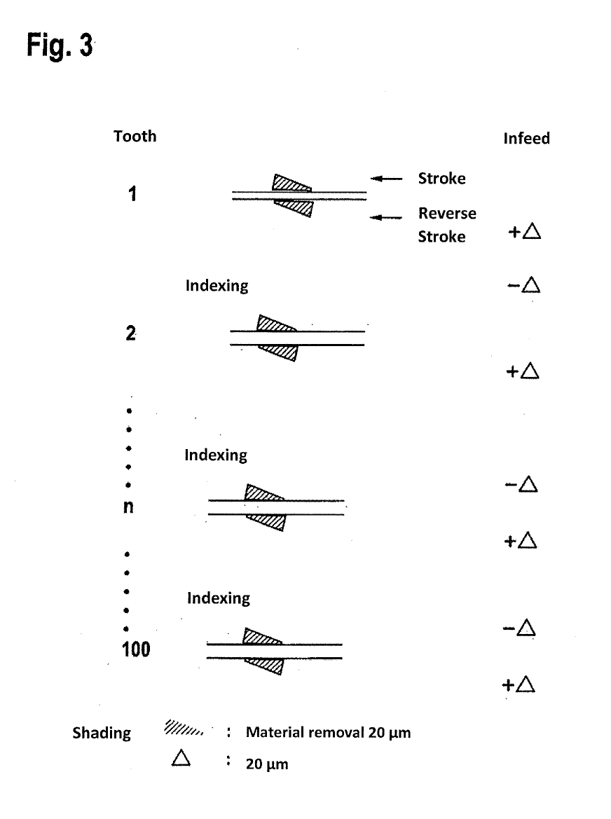

FIG. 3 is a schematic representation of material removal by the single-indexing method according to the invention.

FIG. 1 displays a shaving cutter grinding machine 100, the main components of which are a machine bed 20, a unit 30 for the powered and positionable bearing of a shaving cutter W and a unit 40 for the powered and positionable bearing of a grinding disk S. Further secondary components, such as a dressing device, are not shown in FIG. 1.

The shaving cutter W is retained in a rotatably driven manner by a workpiece slide 32, which can be moved over the machine axis V along the bed 20 to provide tangential stroke and reverse stroke movement, while the rotational axis of the shaving cutter is identified with C.

The grinding disk unit 40 comprises the grinding disk S, which is rotatable about its axis, on a slide arrangement, wherein a height of the grinding disk can be set via the positioning axis X and an orientation of the grinding disk axis can be set via the rotational axes A, B, wherein axis A serves to make adjustments relative to the angle of inclination, and axis B serves to make adjustments relative to the angle of engagement. In addition, the depth of cut can be modified using the movement axis W_{S}.

In FIG. 1, the grinding disk S and the shaving cutter W are shown in processing engagement, which occurs in accordance with the principle of the rolling motion produced by superimposing the tangential stroke movement in direction Y_{W} with the rotation of the shaving cutter, which was discussed at the beginning with reference to FIG. 2.

In the following exemplary case described on the basis of FIG. 3, 40 μm of material is supposed to be removed in one cycle from the tooth flanks of a shaving cutter having e.g. 100 teeth.

This is accomplished by setting half of the desired removal amount, 20 μm, as the feed increment and removing this material in the stroke movement (+Y_{W}) via the rolling processing engagement. Even before the grinding disk rolls back out of the engagement position (−Y_{W}) to continue indexing, material is also deliberately removed while it is rolling out as a result of changing the infeed, namely an infeed that is a further 20 μm deeper.

Before the roll-in movement commences to the next index, the infeed is reset to the depth during the stroke of the previous pitch, after which the second tooth is processed like the first, and so forth. In this method, 200 grinding passes are performed and zero idle passes, and the total removal of 40 μm is achieved in one processing cycle.

This is only an illustrative example, but it reveals that more removal per processing cycle and thus fewer overall cycles are possible (or less removal per grinding stroke is necessary with the same number of processing cycles) in order to accomplish the same processing results as in the prior art.

If we consider, for instance, the measures usually taken in the prior art to grind a newly manufactured shaving cutter, in which e.g. four rough cycles, three finishing cycles and two spark-out cycles take place, then the process control according to the invention will suffice with just two rough cycles, one finishing cycle with a grinding stroke in the return stroke and possibly one further finishing cycle with an idle stroke in the return stroke as well as the spark-out cycles. On the whole, this can result in up to approximately 25% lower processing times.

In the embodiment, a grinding disk is operating. However, the invention can also be implemented for double-disk arrangements, in which both disks simultaneously process two tooth flanks that are usually a few tooth gaps apart.

Incidentally, the invention is also not restricted to the details shown in the above examples. Instead, the individual features in the claims which follow and in the description, individually and in combination, can be essential to realizing the invention in its various embodiments.

1. A method for the fine-processing of a toothing (W) by a single-indexing method, wherein a disk-type fine-toothing tool (S) that rotates about its axis is brought into rolling processing engagement with a tooth flank of the toothing in order to remove material from the tooth flank, wherein a line contact is established while in processing engagement, and the contact line moves over the tooth flank in accordance with a movement having a directional component that is radial to the toothing axis,
characterized in that the processing engagement is maintained in the same pitch with a reduced tangential distance between the tooth flank and the disk plane of the fine-processing tool and with a sign reversal of the radial directional component of the contact line displacement.

2. The method according to claim 1, wherein the tangential distance for the processing engagement is increased again on the next tooth flank after the indexing.

3. The method according to claim 1, wherein the total amount of material removed to achieve the desired final dimensions is distributed over multiple processing cycles of the toothing, and the process can be continued in one or more processing cycles with a reduction in the tangential distance and the sign reversal in the radial directional component in the respective pitch.

4. The method according to claim 3, wherein no further reduction in the tangential distance is undertaken in a later cycle in which material is deliberately removed.

5. The method according to claim 1 wherein a relative movement between the fine-processing tool and the processed toothing to establish the processing engagement is that of a mechanical rolling arc, though it is carried out by synchronized CNC-controlled axes of movement.

6. The method according to claim 5, wherein the relative movement is produced by superimposing a rotational movement of the toothing about its rotary axis and a linear movement of the toothing transversely to its rotary axis.

7. The method according to claim 1 wherein the fine-processing tool does not perform any other movements besides its rotational movement during a processing cycle of the toothing.

8. The method according to claim 1 wherein the processed toothing is the toothing of a cylindrical gear-cutting tool.

9. The method according to claim 8, wherein a shaving cutter can be ground by the method.

10. A computer program that, when run on a fine-processing machine suitable for performing a method according to claim 1, controls the fine-processing machine to perform said method.

11. A fine-processing machine (100) having a controller that controls the machine to carry out a method according to claim 1.

12. The method according to claim 2, wherein the tangential distance for the processing engagement is increased again on the next tooth flank after the indexing by the same amount as the preceding reduction.

13. The method of claim 3 wherein said one or more processing cycles comprises the first processing cycle.

14. The method according to claim 4, wherein no further reduction in the tangential distance is undertaken in the last cycle in which material is deliberately removed.
